(19) United States
(12) Patent Application Publication
(10) Pub. No.: US 2026/0368279 A1
(43) Pub. Date: Nov. 19, 2026

(54) APPARATUS FOR AND METHOD OF CLASSIFYING MONITORING SENSORS OF ARTIFICIAL SATELLITES

(71) Applicant: KOREA AEROSPACE RESEARCH INSTITUTE, Daejeon (KR)

(72) Inventors: Kyung Keun KIM, Daejeon (KR); Yungoo HUH, Daejeon (KR)

(21) Appl. No.: 19/380,412

(22) Filed: Nov. 5, 2025

(30) Foreign Application Priority Data
May 19, 2025 (KR) 10-2025-0064733

(51) Int. Cl. G06F 18/24; G06F 18/23

(52) U.S. Cl. CPC G06F 18/24; G06F 18/23

(57) ABSTRACT

An apparatus for classifying monitoring sensors includes a processor, and memory storing instructions executable by the processor, wherein the processor includes a data obtaining module configured to obtain sensor data from a plurality of sensors and preprocess abnormal data from among the sensor data, a clustering module configured to cluster a plurality of sensors into a plurality of groups by using a preset classification algorithm, a statistical value calculating module configured to calculate a statistical value representing homogeneity of sensor data of each group including a plurality of sensors, and a sensor classifying module configured to classify a sensor to be monitored in each group based on the statistical value.

### CROSS-REFERENCE TO RELATED APPLICATION

This application is based on and claims priority under 35 U.S.C. § 119 to Korean Patent Application No. 10-2025-0064733, filed on May 19, 2025, in the Korean Intellectual Property Office, the disclosure of which is incorporated by reference herein in its entirety.

### BACKGROUND

### 1. Field

The disclosure relates to an apparatus for and method of classifying monitoring sensors.

### 2. Description of the Related Art

In the related art, a method of monitoring a plurality of sensors mainly includes simply monitoring the current values of all sensors and determining whether the sensor value reaches a particular value. For example, due to the characteristics of a temperature measurement test in which physical connection is important, a method of simply monitoring all sensor values without considering the correlation or behavioral specificity between the respective sensors may be effective in a test using a small number of sensors but may be unsuitable for testing large equipment with hundreds of sensors. Particularly, it may be necessary to monitor up to 1,000 temperature sensors in order to monitor the temperature of an artificial satellite.

### SUMMARY

Provided is an apparatus for and method of classifying monitoring sensors, which are capable of solving various problems including the above problems. However, these problems are merely examples and the scope of the disclosure is not limited thereto.

Additional aspects will be set forth in part in the description which follows and, in part, will be apparent from the description, or may be learned by practice of the presented embodiments of the disclosure.

According to an aspect of the disclosure, a monitoring sensor classifying apparatus includes a processor, and memory storing instructions executable by the processor, wherein the processor includes a data obtaining module configured to obtain sensor data from a plurality of sensors and preprocess abnormal data from among the sensor data, a clustering module configured to cluster a plurality of sensors into a plurality of groups by using a preset classification algorithm, a statistical value calculating module configured to calculate a statistical value representing homogeneity of sensor data of each group including a plurality of sensors, and a sensor classifying module configured to classify a sensor to be monitored in each group based on the statistical value.

The data obtaining module may be further configured to obtain sensor data including sequential temperature data from each of a plurality of sensors, classify abnormal data from among the sensor data based on a preset abnormal data consideration condition, and convert the abnormal data into temperature data one second ago.

The clustering module may be further configured to calculate a K value, which is a number of the plurality of groups, based on an elbow method and a silhouette score.

The statistical value calculating module may be further configured to calculate a statistical value including an average variance, an average standard deviation, and an average correlation coefficient.

The sensor classifying module may be further configured to identify a group including an abnormal sensor among the plurality of groups based on the statistical value, exclude the abnormal sensor from a monitoring target, and classify a sensor in the group.

The sensor classifying module may be further configured to classify a sensor in the group by excluding an abnormal sensor, whose correlation with other sensors in the group is less than a preset threshold, from the group through a correlation coefficient analysis based on the average correlation coefficient.

According to another aspect of the disclosure, a monitoring sensor classifying method includes obtaining sensor data from a plurality of sensors and preprocessing abnormal data from among the sensor data, clustering a plurality of sensors into a plurality of groups by using a preset classification algorithm, calculating a statistical value representing homogeneity of sensor data of each group including a plurality of sensors, and classifying a sensor to be monitored in each group based on the statistical value.

The obtaining of the sensor data may include obtaining sensor data including sequential temperature data from each of a plurality of sensors, and classifying abnormal data from among the sensor data based on a preset abnormal data consideration condition and converting the abnormal data into temperature data one second ago.

The clustering may include calculating a K value, which is a number of the plurality of groups, based on an elbow method and a silhouette score.

The calculating of the statistical value may include calculating a statistical value including an average variance, an average standard deviation, and an average correlation coefficient.

The classifying of the sensor may include identifying a group including an abnormal sensor among the plurality of groups based on the statistical value, excluding the abnormal sensor from a monitoring target, and classifying a sensor in the group.

The classifying of the sensor may include classifying a sensor in the group by excluding an abnormal sensor, whose correlation with other sensors in the group is less than a preset threshold, from the group through a correlation coefficient analysis based on the average correlation coefficient.

According to another aspect of the disclosure, a computer program is stored in a recording medium to execute the above method by using a computer.

Other aspects, features, and advantages other than those described above will become apparent from the following detailed description, the appended claims, and the accompanying drawings.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing a configuration and operation of a apparatus for classifying monitoring sensors according to an embodiment;

FIG. 2 is a diagram for describing a configuration and operation of a processor included in an apparatus for classifying monitoring sensors, according to an embodiment;

FIG. 3 is a flowchart for describing a method of classifying monitoring sensors according to an embodiment;

FIG. 4 is a diagram for describing a heat transfer amount of an artificial satellite according to a heat transfer equation in a space environment, according to an embodiment;

FIG. 5 is a diagram for describing an example of a screened sensor value according to an embodiment;

FIG. 6 is a diagram for describing an example of a preprocessed sensor value according to an embodiment;

FIG. 7 is a flowchart of a method of preprocessing a sensor value according to an embodiment;

FIGS. 8 to 10 are diagrams for describing a method of classifying monitoring sensors according to an embodiment;

FIG. 11 is a diagram illustrating a statistical value of a monitoring sensor group according to an embodiment; and

FIGS. 12 and 13 are diagrams illustrating an example for comparing a temperature distribution and a statistical value before and after sensor classification, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure may include various embodiments and modifications, and certain embodiments thereof are illustrated in the drawings and will be described herein in detail. The advantages and features of the disclosure and the accomplishing methods thereof will become apparent from the embodiments described below in detail with reference to the accompanying drawings. However, the disclosure is not limited to the embodiments described below, and may be embodied in various modes.

Hereinafter, embodiments will be described in detail with reference to the accompanying drawings, and in the following description, like reference numerals will denote like elements and redundant descriptions thereof will be omitted.

It will be understood that although terms such as “first” and “second” may be used herein to describe various elements, these elements should not be limited by these terms and these terms are only used to distinguish one element from another element. Also, as used herein, the singular forms “a”, “an”, and “the” are intended to include the plural forms as well, unless the context clearly indicates otherwise. Also, it will be understood that the terms “comprise,” “include,” and “have” used herein specify the presence of stated features or components, but do not preclude the presence or addition of one or more other features or components.

Sizes of elements in the drawings may be exaggerated for convenience of description. In other words, because the sizes and shapes of components in the drawings are arbitrarily illustrated for convenience of description, the disclosure is not limited thereto.

It will be understood that when an element such as an area, component, unit, block, or module is referred to as being on or over another element, it may be directly on or over the other element or may be indirectly on or over the other element with one or more intervening areas, components, units, blocks, or modules therebetween. Also, when areas, components, units, blocks, or modules are referred to as being connected to each other, the areas, components, units, blocks, or modules may be directly connected to each other or may be indirectly connected to each other with one or more intervening areas, components, units, blocks, or modules therebetween.

Hereinafter, various embodiments will be described in detail with reference to the accompanying drawings so that those of ordinary skill in the art may easily implement the disclosure.

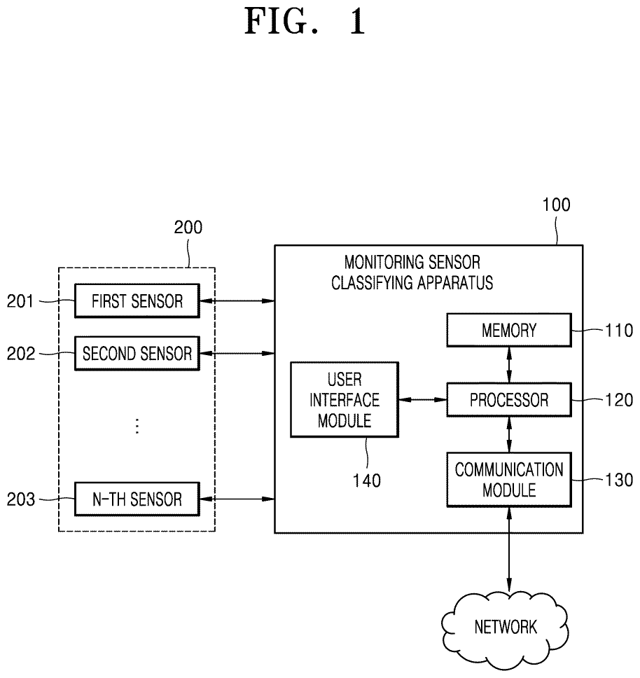

FIG. 1 is a diagram for describing a configuration and operation of an apparatus for classifying monitoring sensors according to an embodiment.

Referring to FIG. 1, an apparatus 100 for classifying monitoring sensors according to an embodiment may include memory 110, a processor 120, a communication module 130, and a user interface module 140. However, the disclosure is not limited thereto, and the apparatus 100 may further include other components or some components may be omitted. Some components of the apparatus 100 may be divided into a plurality of devices or a plurality of components may be combined into a single device.

The apparatus 100 may communicate with a monitoring sensor 200, receive a sensor value from the monitoring sensor 200, and monitor the monitoring sensor 200. For example, as illustrated in FIG. 1, the monitoring sensor 200 may include a first sensor 201, a second sensor 202, and an n-th sensor 203. The number of sensors included in the monitoring sensor 200 is not limited. For example, the monitoring sensor 200 may include a temperature sensor for measuring temperature. In an embodiment, the monitoring sensor 200 may include a sensor installed in an artificial satellite to measure a temperature of the artificial satellite.

The communication module 130 may provide a function for communicating with an external device through a network. For example, a request generated by the processor 120 according to the program code stored in a recording device such as the memory 110 may be transmitted to the external device through the network under the control of the communication module 130. Conversely, control signals, commands, content, files, or the like provided from the external device may be received by the monitoring sensor classifying apparatus 100 through the communication module 130 via the network. For example, the control signals or commands of the external device received through the communication module 130 may be transmitted to the processor 120 or the memory 110.

The communication method is not limited thereto and may also include not only a communication method using a communication network (e.g., a mobile communication network, a wired internet, a wireless internet, or a broadcasting network) that the network may include, but also a short-range wireless communication between devices. For example, the network may include one or more of networks such as Personal Area Network (PAN), Local Area Network (LAN), Campus Area Network (CAN), Metropolitan Area Network (MAN), Wide Area Network (WAN), Broadband Network (BBN), and the Internet. Also, the network may include one or more of network topologies including bus networks, star networks, ring networks, mesh networks, star-bus networks, tree or hierarchical networks, and the like but is not limited thereto.

Also, the communication module 130 may communicate with an external server through a network. The communication method is not limited thereto and the network may be a short-range wireless communication network. For example, the network may be a Bluetooth network, a Bluetooth Low Energy (BLE) network, or a WiFi network.

The monitoring sensor classifying apparatus 100 according to the disclosure may include the user interface module 140. For example, the user interface module 140 may be a unit for interfacing with an input/output device. For example, an input device may include a device such as a keyboard or a mouse, and an output device may include a device such as a display for displaying a communication session of an application. As another example, the user interface module 140 may be a unit for interfacing with a device such as a touch screen in which functions for input and output are integrated into one. More particularly, when the processor 120 processes a command of a computer program loaded in the memory 110, a service screen or content configured by using data provided by an external device may be displayed on a display through the user interface module 140.

The memory 110 may be a computer-readable recording medium and may include a permanent mass storage device such as a random-access memory (RAM), a read-only memory (ROM), and a disk drive. Also, program code for controlling the monitoring sensor classifying apparatus 100 may be temporarily or permanently stored in the memory 110.

The processor 120 may control an overall operation of the monitoring sensor classifying apparatus 100. For example, in order to perform the above operation, the processor 120 may be implemented in a form that selectively includes a processor, an application-specific integrated circuit (ASIC), another chipset, a logic circuit, a register, a communication modem, and/or a data processor that are known in the art. For example, the processor 120 may perform basic arithmetic, logic, and input/output operations and may execute the program code stored in the memory 110. The processor 120 may store data in the memory 110 or load the data stored in the memory 110.

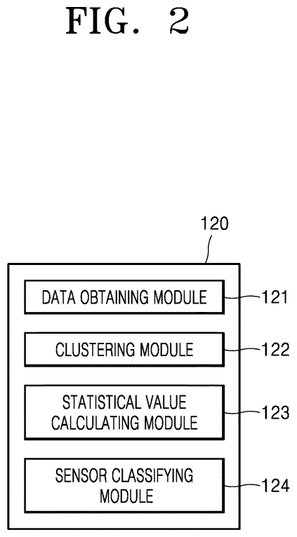

FIG. 2 is a diagram for describing the configuration and operation of a processor included in a monitoring sensor classifying apparatus, according to an embodiment.

Referring to FIG. 2, the processor 120 according to an embodiment may include a data obtaining module 121, a clustering module 122, a statistical value calculating module 123, and a sensor classifying module 124.

The data obtaining module 121 may obtain sensor data from a plurality of sensors. For example, the data obtaining module 121 may obtain sensor data including sequential temperature data from each of the plurality of sensors. Also, the data obtaining module 121 may preprocess abnormal data from among the sensor data. For example, the data obtaining module 121 may classify abnormal data from among the sensor data based on a preset abnormal data consideration condition and convert the abnormal data into temperature data one second ago.

The clustering module 122 may cluster a plurality of sensors into a plurality of groups by using a preset classification algorithm. For example, the clustering module 122 may calculate a K value, which is a number of the plurality of groups, based on an elbow method and a silhouette score.

The statistical value calculating module 123 may calculate a statistical value representing the homogeneity of sensor data of each group including a plurality of sensors. For example, the statistical value calculating module 123 may calculate a statistical value including an average variance, an average standard deviation, and an average correlation coefficient.

The sensor classifying module 124 may classify a sensor to be monitored in each group based on the statistical value. The sensor classifying module 124 may identify a group including an abnormal sensor among the plurality of groups based on the statistical value, exclude the abnormal sensor from a monitoring target, and classify a sensor in the group.

For example, the sensor classifying module 124 may classify a sensor in the group by excluding an abnormal sensor, whose correlation with other sensors in the group is less than a preset threshold, from the group through a correlation coefficient analysis based on the average correlation coefficient.

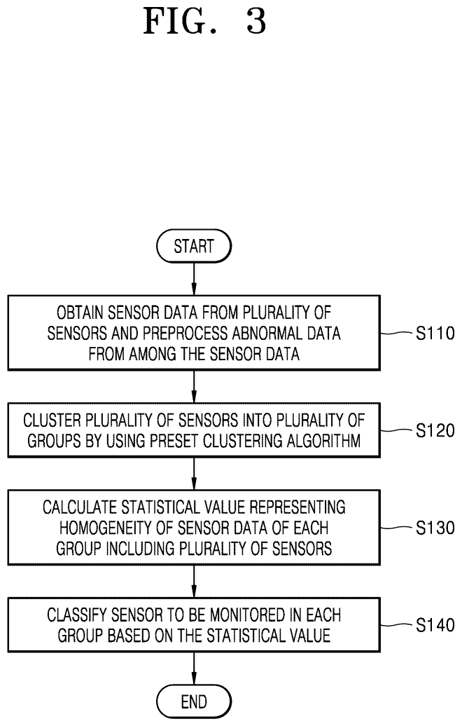

FIG. 3 is a flowchart for describing a method of classifying monitoring sensors according to an embodiment.

Referring to FIG. 3, in operation S110, the apparatus for classifying monitoring sensors according to an embodiment may obtain sensor data from a plurality of sensors. For example, the apparatus for classifying monitoring sensors may obtain sensor data including sequential temperature data from each of the plurality of sensors. Also, the apparatus for classifying monitoring sensors according to an embodiment may preprocess abnormal data from among the sensor data.

In operation S120, the apparatus for classifying monitoring sensors according to an embodiment may cluster a plurality of sensors into a plurality of groups by using a preset classification algorithm. For example, the apparatus for classifying monitoring sensors may calculate a K value, which is a number of the plurality of groups, based on an elbow method and a silhouette score.

In operation S130, the apparatus for classifying monitoring sensors according to an embodiment may calculate a statistical value representing the homogeneity of sensor data of each group including a plurality of sensors. For example, the apparatus for classifying monitoring sensors may calculate a statistical value including an average variance, an average standard deviation, and an average correlation coefficient.

In operation S140, the apparatus for classifying monitoring sensors according to an embodiment may classify a sensor to be monitored in each group based on the statistical value. For example, the apparatus for classifying monitoring sensors may classify a sensor in the group by excluding an abnormal sensor, whose correlation with other sensors in the group is less than a preset threshold, from the group through a correlation coefficient analysis based on the average correlation coefficient.

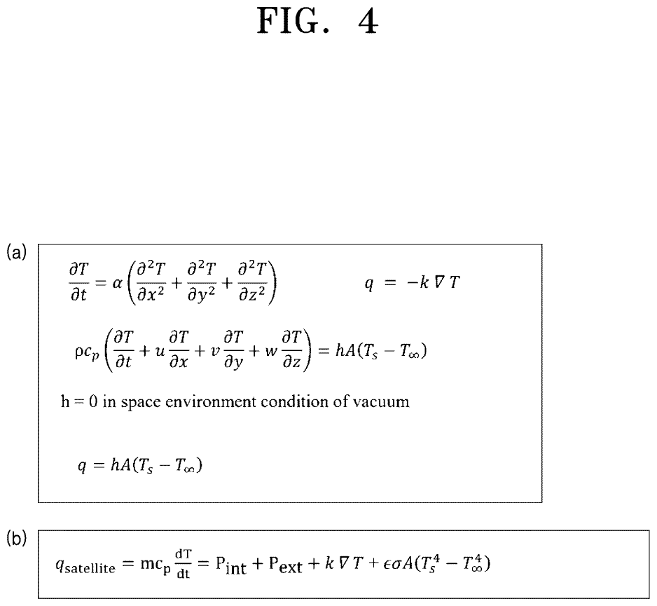

FIG. 4 is a diagram for describing a heat transfer amount of an artificial satellite according to a heat transfer equation in a space environment, according to an embodiment.

In the method of classifying monitoring sensors according to an embodiment, a sensor may be classified through grouping by using sensor data generated during a thermal vacuum test of an artificial satellite, and an abnormal operation of the sensor may be sensed by using the classification.

For example, as illustrated in FIG. 4, in the method of classifying monitoring sensors according to an embodiment, a heat transfer amount of a satellite may be calculated by using a heat transfer governing equation (a) in a space environment, which includes a conduction heat transfer equation, a convection heat transfer equation, and a radiation heat transfer equation, and an artificial satellite boundary condition (b) in a space environment, which considers conduction heat transfer and radiation heat transfer, may be used. For example, in the artificial satellite heat transfer amount, the energy inflow may represent the internal heat generation and the amount of heat generated by a heater, and the energy outflow may represent the amount of heat discharged to the outside.

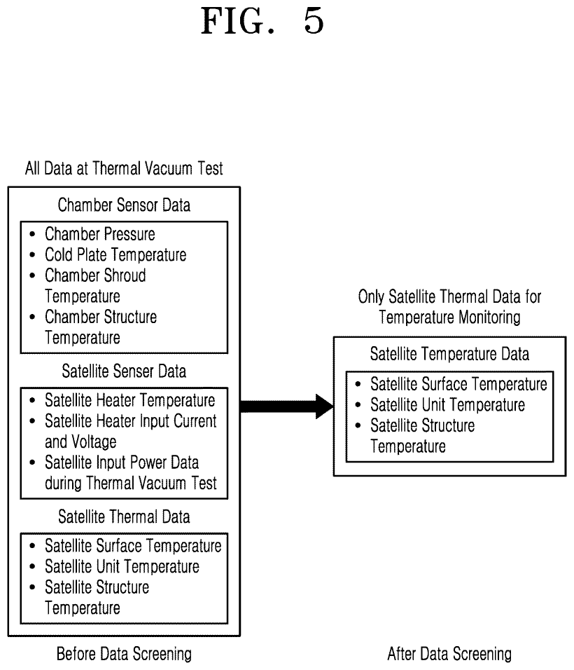

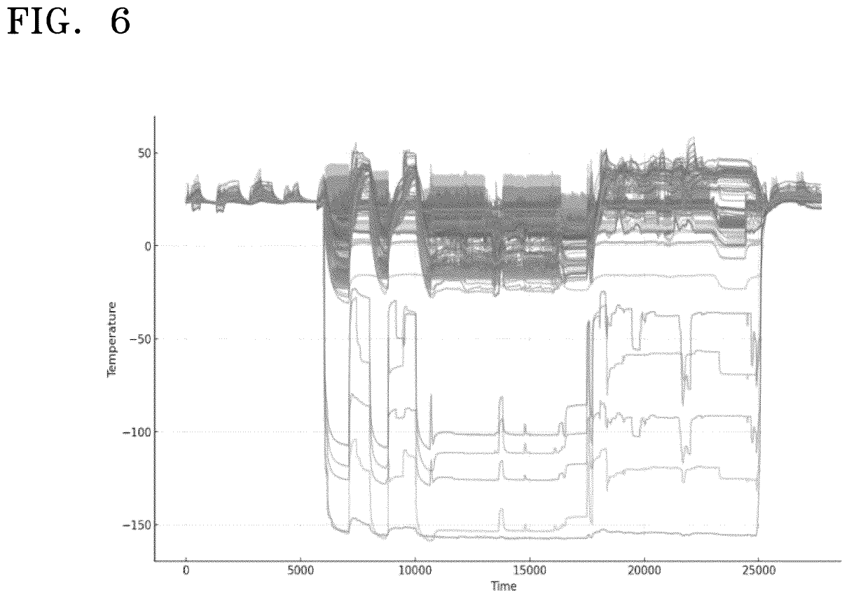

FIG. 5 is a diagram for describing an example of a screened sensor value according to an embodiment. FIG. 6 is a diagram for describing an example of a preprocessed sensor value according to an embodiment.

Referring to FIG. 5, in the method of classifying monitoring sensors according to an embodiment, a sensor value unrelated to a temperature change in an artificial satellite may be screened and excluded from input data. Particularly, when all sensor data used in an initial thermal vacuum test is collected, only data related to the temperature change may be obtained and the chamber surface temperature, pressure data, and heater data unrelated to the temperature change may not be obtained.

Also, from among the data related to the temperature change, abnormal data may be replaced. In the case of the abnormal data, by replacing data one second ago, the data may be converted into processable time-series data. Also, preprocessed data may be standardized and converted into a data frame in a format applicable to an algorithm.

Referring to FIG. 6, an example of preprocessed data used in the method of classifying monitoring sensors according to an embodiment is illustrated.

The preprocessed data may represent a preprocessed thermal vacuum test result as a data set to which a machine learning algorithm may be applied. For example, the preprocessed data illustrated in FIG. 6 may be a satellite surface and a unit surface temperature sensor value related to a temperature change in an artificial satellite and may represent preprocessed data preprocessed according to a preprocessing condition (e.g., the test period: about 20 days, the number of sensors: 100, the data generation period: 1 second, the total number of data sets: about 100 million sets, and the data capacity: about 1 gigabyte).

For example, when data is marked as “no data” and no data is measured, data one second ago may be used. Also, data one second ago may be used as data marked as infinite due to a measurement error. For example, in order to classify data of a measurement error, abnormal data may be considered by using the condition of the following equation. In the case of the abnormal data, data one second ago may be used.

ΔT>1 °C, 1 second=>considered as abnormal data

Because the amount of temperature change per second is limited due to conduction and radiation heat transfer, a temperature change exceeding 1 degree per second may be classified as abnormal data and preprocessed.

Also, in order to effectively learn a temperature change over time, data may be classified in a time-temperature format and converted into time-series data.

Through MinMaxScaler of a scikit-learn library, the preprocessed data may be normalized and converted into training data in the [0,1] range. For example, when an x value has a minimum value xₘᵢₙ and a maximum value xₘₐₓ, a scaled value x′ may be calculated as follows.

$${x}^{′} = \frac{x - {x}_{min}}{{x}_{max} - {x}_{min}}$$

For example, the preprocessed data may be used for training after preprocessing through the MinMaxScaler.

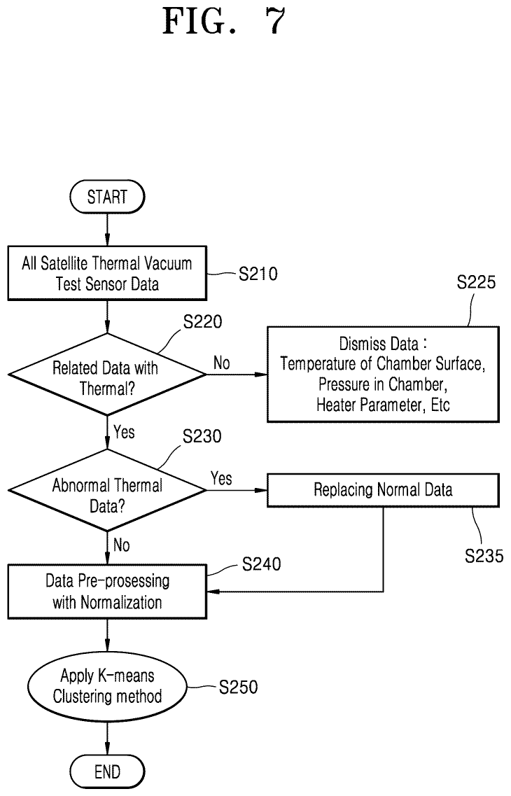

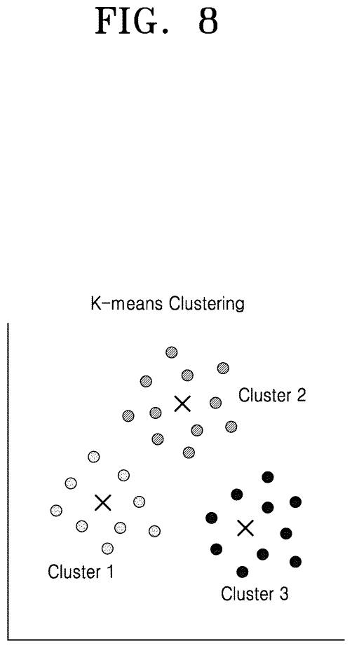

FIG. 7 is a flowchart for describing a sensor value preprocessing method according to an embodiment. FIGS. 8 to 10 are diagrams for describing a monitoring sensor classifying method according to an embodiment.

Referring to FIG. 7, in operation S210, the monitoring sensor classifying apparatus according to an embodiment may receive a sensor value of a monitoring sensor in an artificial satellite thermal vacuum test. For example, all sensor data used in the thermal vacuum test may be collected.

In operation S220, the monitoring sensor classifying apparatus according to an embodiment may screen data related to the temperature of the artificial satellite.

In operation S225, the monitoring sensor classifying apparatus according to an embodiment may remove data unrelated to the temperature of the artificial satellite. For example, a chamber surface temperature, pressure data, heater data, and the like unrelated to a temperature change may be removed.

In operation S230, the monitoring sensor classifying apparatus according to an embodiment may identify abnormal temperature data.

In operation S235, the monitoring sensor classifying apparatus according to an embodiment may replace the abnormal temperature data with normal temperature data. For example, the monitoring sensor classifying apparatus may replace the abnormal temperature data with data one second ago to replace data with processable time-series data.

In operation S240, the monitoring sensor classifying apparatus according to an embodiment may standardize the preprocessed data into a data frame in a form applicable to an algorithm.

In operation S250, the monitoring sensor classifying apparatus according to an embodiment may perform K-means clustering by using the standardized preprocessed data. For example, as illustrated in FIG. 8, the K-means clustering may represent a method of grouping by finding the minimum distance by calculating the distance between each cluster and K allocated centers. For example, K groups may be set through the K-means clustering.

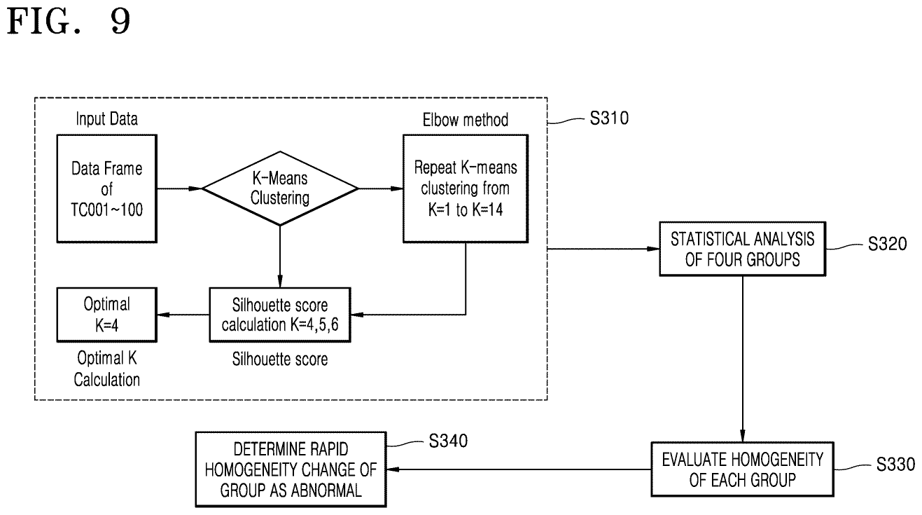

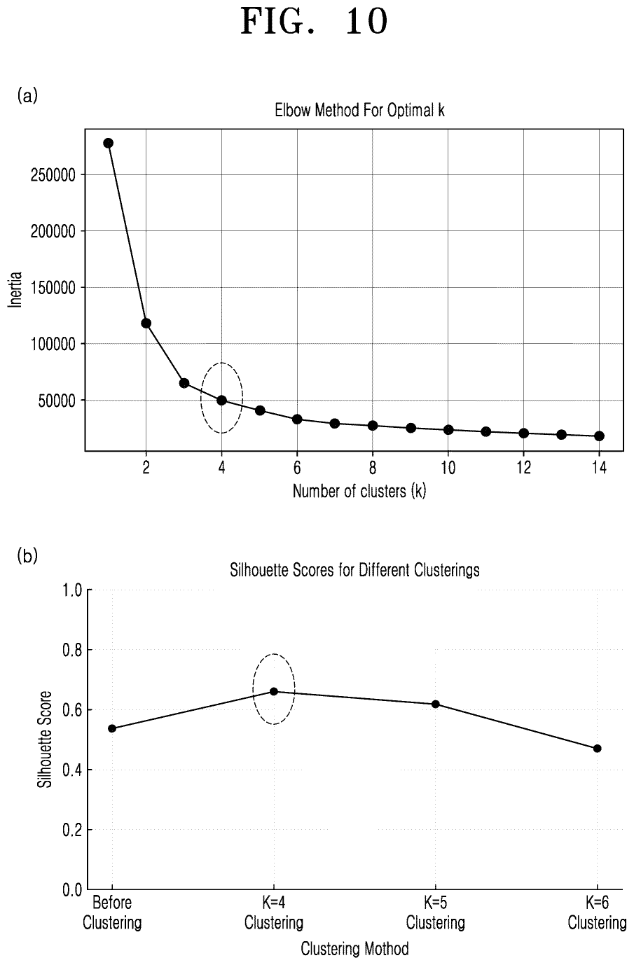

Referring to FIG. 9, in operation S310, the monitoring sensor classifying apparatus according to an embodiment may obtain a temperature change amount over time in the preprocessed temperature sensors no. 1 to no. 100 as input data. Subsequently, the monitoring sensor classifying apparatus may perform k-means clustering by using the input data. Subsequently, the monitoring sensor classifying apparatus may calculate an optimal group number K by using an elbow method and a silhouette score. For example, as illustrated in FIG. 10, the monitoring sensor classifying apparatus may find an optimal group number k candidate group using the elbow method by repeatedly performing the process from K=1 to K=14 by using the elbow method and the silhouette score and may calculate an optimal group number k=4 among the candidate group of K=4, 5, and 6 by using the silhouette score. Subsequently, the monitoring sensor classifying apparatus may cluster the sensor group into four groups.

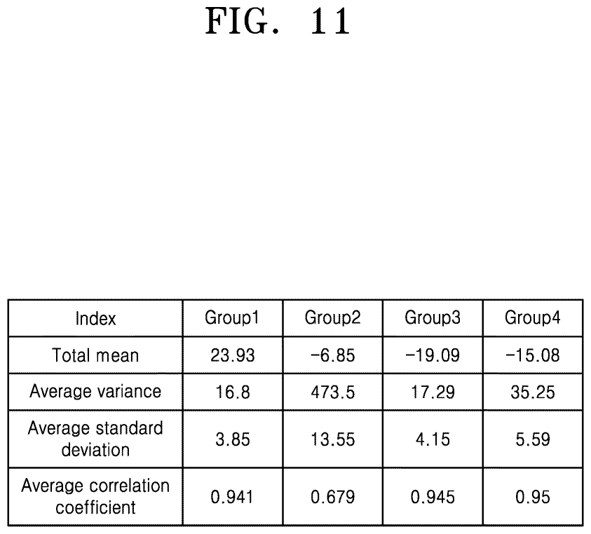

In operation S320, the monitoring sensor classifying apparatus according to an embodiment may calculate a statistical value (e.g., the mean, variance, standard deviation, and correlation coefficient illustrated in FIG. 11) for four groups through a statistical analysis when K=4. For example, the statistical analysis may be used to analyze whether the groups are well distributed. For example, group classification may be used to classify the groups into a high-sensitivity group, a medium-sensitivity group, and a low-sensitivity group, and the high-sensitivity group may be selected as a main monitoring group to increase the monitoring efficiency.

In operation S330, the monitoring sensor classifying apparatus according to an embodiment may evaluate the homogeneity of each group. For example, the homogeneity according to the disclosure may represent the correlations between sensors in the group. In other words, the homogeneity may be a value representing the correlation with other sensors in the group through a correlation coefficient analysis based on the average correlation coefficient calculated based on the statistical value.

In operation S340, the monitoring sensor classifying apparatus according to an embodiment may determine an abnormal group through a homogeneity analysis. For example, the monitoring sensor classifying apparatus may determine an abnormality when the group homogeneity is found in the form of an outlier in one group. For example, the monitoring sensor classifying apparatus may classify a sensor in the group by excluding an abnormal sensor, whose correlation with other sensors in the group is less than a preset threshold, from the group through a correlation coefficient analysis based on the average correlation coefficient.

In a temperature sensor classifying method of the related art, because existing satellites are not mass-produced, there is no standard for the temperature sensor classifying method, and in practice, sensors are classified according to the positions and structures of satellites. However, in the sensor classifying method according to the disclosure, a sensor grouping method through classification may be proposed in a situation where a sensor classifying method in a satellite test is not available.

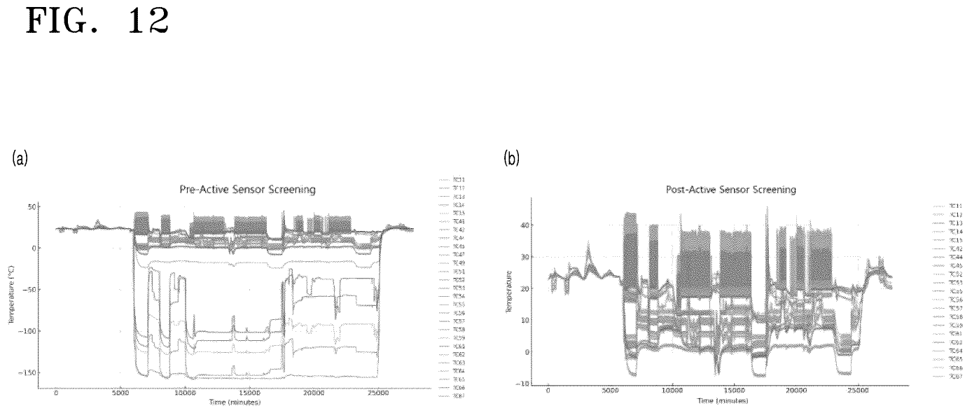

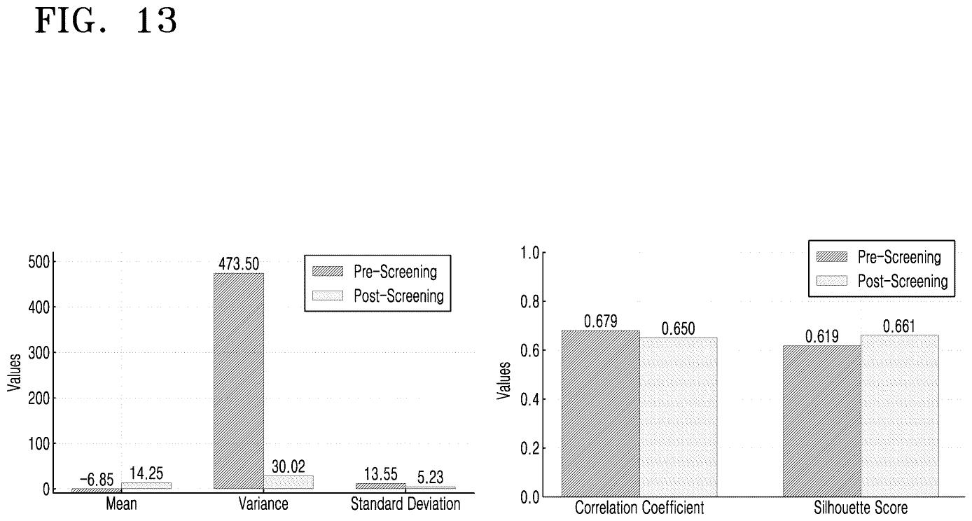

FIG. 11 is a diagram illustrating a statistical value of a monitoring sensor group according to an embodiment. FIGS. 12 and 13 are diagrams illustrating an example of the comparison of the temperature distribution and the statistical value before and after sensor classification, according to an embodiment.

Referring to FIG. 11, according to the disclosure, through a statistical analysis, a sensor that does not requires monitoring may be classified by removing a sensor unrelated to monitoring from the monitoring sensor group grouped into four groups. As illustrated in FIG. 11, because the average correlation coefficient of Group 2 corresponds to 0.679 that is less than a threshold (e.g., 0.8), an abnormal sensor included in Group 2 may be excluded from the group and a sensor in the group may be classified. For example, through a correlation coefficient analysis, an abnormal sensor whose correlation with other sensors in the group is less than a preset threshold may be excluded from the group, and a sensor in the group may be classified.

FIG. 12(a) illustrates the temperature distribution before the abnormal sensor is removed, and FIG. 12(b) illustrates the temperature distribution after the abnormal sensor is removed. Also, referring to FIG. 13, the statistical value may be improved because a sensor in the group is classified by removing an abnormal sensor through the comparison of the statistical value, the correlation coefficient, and the silhouette score before and after the removal of an abnormal sensor with low correlation.

According to the disclosure, the monitoring efficiency may be increased by removing an outlier (abnormal) sensor in a satellite test in which hundreds of sensors should be monitored. Also, according to the disclosure, the cost of a thermal vacuum test performed for 2 weeks to 4 weeks may be reduced by reducing the number of participants in the thermal vacuum test in a situation where the number of monitoring thermal engineers is limited.

The apparatuses and/or systems described above may be implemented as hardware components, software components, and/or a combination of hardware components and software components. For example, the apparatuses and components described in the embodiments may be implemented by using one or more general-purpose computers or special-purpose computers such as processors, controllers, arithmetic logic units (ALUs), digital signal processors, microcomputers, field programmable gate arrays (FPAs), programmable logic units (PLUS), microprocessors, or any other apparatuses capable of executing and responding to instructions. The processor may execute an operating system (OS) and one or more software applications that are executed on the OS. Also, the processor may access, store, operate, process, and generate data in response to execution of the software. For convenience of understanding, the processor may be described as being used singly; however, those of ordinary skill in the art will understand that the processor may include a plurality of processing elements and/or a plurality of types of processing elements. For example, the processor may include a plurality of processors or one processor and one controller. Also, other processing configurations such as parallel processors may also be possible.

The software may include computer programs, code, instructions, or a combination of one or more thereof and may configure the processor to operate as desired or may instruct the processor independently or collectively. The software and data may be stored on one or more computer-readable recording mediums.

The method according to an embodiment may be embodied in the form of program instructions executable through various computer means, which may be recorded on a computer-readable recording medium. The computer-readable recording medium may include program instructions, data files, and data structures either alone or in combination. The program instructions recorded on the computer-readable recording medium may be those that are especially designed and configured for the embodiment, or may be those that are known and available to those of ordinary skill in computer software. Examples of the computer-readable recording medium include magnetic media such as hard disks, floppy disks, and magnetic tapes, optical media such as CD-ROMs and DVDs, magneto-optical media such as floptical disks, and hardware devices that are specially configured to store and execute program instructions. Examples of the program instructions include not only machine language codes such as those generated by compilers, but also high-level language codes that may be executed by computers by using interpreters or the like.

The hardware device described above may be configured to operate as one or more software modules in order to perform the operation of an embodiment, and vice versa.

As described above, according to an embodiment, a monitoring sensor classifying apparatus and method capable of improving monitoring efficiency may be provided. However, the scope of the disclosure is not limited to these effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An apparatus for classifying monitoring sensors, the apparatus comprising:
a processor; and
memory storing instructions executable by the processor,
wherein the processor comprises:
a data obtaining module configured to obtain sensor data from a plurality of sensors and preprocess abnormal data from among the sensor data;
a clustering module configured to cluster a plurality of sensors into a plurality of groups by using a preset classification algorithm;
a statistical value calculating module configured to calculate a statistical value representing homogeneity of sensor data of each group including a plurality of sensors; and
a sensor classifying module configured to classify a sensor to be monitored in each group based on the statistical value.

2. The apparatus of claim 1, wherein the data obtaining module is further configured to:
obtain sensor data including sequential temperature data from each of a plurality of sensors, and
classify abnormal data from among the sensor data based on a preset abnormal data consideration condition and convert the abnormal data into temperature data one second ago.

3. The apparatus of claim 1, wherein the clustering module is further configured to calculate a K value, which is a number of the plurality of groups, based on an elbow method and a silhouette score.

4. The apparatus of claim 3, wherein the statistical value calculating module is further configured to calculate a statistical value including an average variance, an average standard deviation, and an average correlation coefficient.

5. The apparatus of claim 4, wherein the sensor classifying module is further configured to identify a group including an abnormal sensor among the plurality of groups based on the statistical value, exclude the abnormal sensor from a monitoring target, and classify a sensor in the group.

6. The apparatus of claim 5, wherein the sensor classifying module is further configured to classify a sensor in the group by excluding an abnormal sensor, whose correlation with other sensors in the group is less than a preset threshold, from the group through a correlation coefficient analysis based on the average correlation coefficient.

7. A method of classifying monitoring sensors, the method comprising:
obtaining sensor data from a plurality of sensors and preprocessing abnormal data from among the sensor data;
clustering a plurality of sensors into a plurality of groups by using a preset classification algorithm;
calculating a statistical value representing homogeneity of sensor data of each group including a plurality of sensors; and
classifying a sensor to be monitored in each group based on the statistical value.

8. The method of claim 7, wherein the obtaining of the sensor data comprises:
obtaining sensor data including sequential temperature data from each of a plurality of sensors; and
classifying abnormal data from among the sensor data based on a preset abnormal data consideration condition and converting the abnormal data into temperature data one second ago.

9. The method of claim 7, wherein the clustering comprises calculating a K value, which is a number of the plurality of groups, based on an elbow method and a silhouette score.

10. The method of claim 9, wherein the calculating of the statistical value comprises calculating a statistical value including an average variance, an average standard deviation, and an average correlation coefficient.

11. The method of claim 10, wherein the classifying of the sensor comprises identifying a group including an abnormal sensor from among the plurality of groups based on the statistical value, excluding the abnormal sensor from a monitoring target, and classifying a sensor in the group.

12. The method of claim 11, wherein the classifying of the sensor comprises classifying a sensor in the group by excluding an abnormal sensor, whose correlation with other sensors in the group is less than a preset threshold, from the group through a correlation coefficient analysis based on the average correlation coefficient.

13. A computer program stored in a computer-readable recording medium to execute the method of classifying monitoring sensors of claim 7 by using a computing device.
